(19) United States
(12) Patent Application Publication
(10) Pub. No.: US 2017/0297137 A1
(43) Pub. Date: Oct. 19, 2017

(54) METHOD OF JOINING ALUMINUM AND STEEL WORKPIECES

(71) Applicant: GM GLOBAL TECHNOLOGY OPERATIONS LLC, Detroit, MI (US)

(72) Inventors: Thomas A. Perry, Bruce Township, MI (US); James G. Schroth, Troy, MI (US); David R. Sigler, Shelby Township, MI (US)

(21) Appl. No.: 15/491,376

(22) Filed: Apr. 19, 2017

Related U.S. Application Data
(60) Provisional application No. 62/324,658, filed on Apr. 19, 2016.

(51) Int. Cl. B23K 11/20; B23K 35/30; B23K 9/30; C22C 9/00; B23K 9/235

(52) U.S. Cl. CPC B23K 11/20; C22C 9/00; B23K 9/235; B23K 9/30; B23K 35/302

(57) ABSTRACT

A method of joining an aluminum workpiece and an adjacent overlapping steel workpiece by reaction metallurgical joining, and the resultant metallurgical joint formed between the two workpieces, are disclosed. The method involves compressing a reaction material located between the aluminum and steel workpieces and heating the reaction material momentarily to form a metallurgical joint that comprises bonding interface between the reaction material and the steel workpiece and a bonding interface between the reaction material and the aluminum workpiece. The reaction material is formulated to be able to interact with both aluminum and steel in order to establish the bonding interfaces of the metallurgical joint. Moreover, the practice of oscillating wire arc welding may be employed to deposit the reaction material in the form of a reaction material deposit onto the steel workpiece prior to assembling the steel and aluminum workpieces in a workpiece stack-up.

### CROSS-REFERENCE(S) TO RELATED APPLICATIONS

This application claims the benefit of U.S. Provisional Application No. 62/324,658 filed on Apr. 19, 2016. The entire contents of the aforementioned provisional application are incorporated herein by reference.

### TECHNICAL FIELD

The technical field of this disclosure relates generally to a method for joining an aluminum workpiece and a steel workpiece by way of reaction metallurgical joining.

### INTRODUCTION

A number of manufacturing industries employ operations in which two or more metal workpieces are joined together. The automotive industry, for example, often uses various forms of welding and/or mechanical fastening to join together metal workpieces during the manufacture of vehicle structural members (e.g., body sides and cross members) and vehicle closure members (e.g., doors, hoods, trunk lids, and lift gates), among others. And while welding and fastening procedures have traditionally been practiced to join together certain similarly composed metal workpieces—namely, aluminum-to-aluminum and steel-to-steel—the desire to incorporate lighter weight materials into a vehicle body structure has generated interest in joining aluminum workpieces to steel workpieces. Other manufacturing industries including the aviation, maritime, railway, and building construction industries are also interested in developing effective and repeatable procedures for joining such dissimilar metal workpieces.

The joining of aluminum and steel workpieces through traditional welding practices, such as spot and laser welding, can be a challenging endeavor given the markedly different properties of aluminum and steel (e.g., solidus and liquidus temperatures and thermal and electrical conductivities). Spot and laser welding processes are also complicated by the fact that a mechanically tough and electrically insulating refractory oxide layer is typically present at the surface of the aluminum workpiece. These challenges facing conventional welding practices can be avoided through the use of mechanical fasteners such as self-piercing rivets and flow-drill screws. But mechanical fasteners are more laborious to install and have high consumable costs compared to welding. Additionally, mechanical fasteners add weight to the vehicle—weight that is avoided when joining is accomplished by way of welding—that offsets some of the weight savings attained through the use of aluminum workpieces in the first place.

The technical and economical obstacles that accompany welding and/or mechanically fastening together an aluminum workpiece and a steel workpiece are not insurmountable. With that being said, alternative techniques that can successfully join together those two types of dissimilar metal workpieces, especially in a manufacturing setting, are still being investigated for a variety of reasons including the desire to broaden the number of available joining options. Low heat input metallurgical joining techniques that do not necessitate melting of the aluminum workpiece, which melts at a significantly lower temperature than the steel workpiece, are of particular interest. Indeed, when the aluminum workpiece is heated to above its liquidus temperature and the resultant molten aluminum wets a broad surface of the steel workpiece, such as during the practice of resistance spot welding, a hard and brittle intermetallic layer comprised of Fe—Al intermetallic compounds forms along the unmelted faying surface of the steel workpiece. This intermetallic layer is susceptible to rapid crack growth and, as a result, can be a cause of interfacial joint fracture when the joined aluminum and steel workpieces are subjected to loading.

### SUMMARY

A method of joining an aluminum workpiece and an adjacent overlapping steel workpiece by reaction metallurgical joining may include several steps according to one embodiment of the present disclosure. In one step, a workpiece stack-up that includes an aluminum workpiece, a steel workpiece, and a reaction material located between the aluminum workpiece and the steel workpiece at a faying interface of the aluminum and steel workpieces is assembled. In another step, the reaction material is compressed between the aluminum workpiece and the steel workpiece. In yet another step, the reaction material is heated momentarily to form a metallurgical joint between the aluminum workpiece and the steel workpiece. The metallurgical joint comprises a bonding interface between the reaction material and the steel workpiece and a bonding interface between the reaction material and the aluminum workpiece, and a Fe—Al intermetallic layer is not present at either of the bonding interface between the reaction material and the steel workpiece or the bonding interface between the reaction material and the aluminum workpiece.

The method of the aforementioned embodiment may include further steps or be further defined. For instance, the reaction material may be comprised of a copper-based reaction material composition that has the capacity to both wet steel and form a low-melting point eutectic alloy with aluminum. In particular, the copper-based reaction material may be pure unalloyed copper or a copper alloy having a minimum copper constituent content of 50 wt %. Several copper alloys that may be used include one of a copper-phosphorus alloy, a copper-silver-phosphorus alloy, a copper-tin-phosphorus alloy, a copper-zinc alloy, an aluminum-bronze alloy, or a silicon-bronze alloy.

Additionally, the bonding interface between the reaction material and the steel workpiece may be a primary braze joint and the bonding interface between the reaction material and the aluminum workpiece may be a primary fusion joint established by an aluminum-copper alloy. And, in some instances, the metallurgical joint may further include a radially extended portion of the aluminum-copper alloy that surrounds the reaction material and establishes a secondary braze joint with the steel workpiece and a secondary fusion joint with the aluminum workpiece. The assembled workpiece stack-up may include (in terms of the number of workpieces) only the aluminum workpiece and the steel workpiece, or it may include an additional aluminum workpiece and/or an additional steel workpiece in addition to the aluminum workpiece and the steel workpiece between which the metallurgical joint is formed.

A method of joining an aluminum workpiece and an adjacent overlapping steel workpiece by reaction metallurgical joining may include several steps according to another embodiment of the present disclosure. In one step, a reaction material comprised of a copper-based reaction material composition is deposited onto a faying surface of a steel workpiece to form a reaction material deposit. This reaction material deposit establishes a bonding interface with the faying surface of the steel workpiece in the form of a primary braze joint. In another step, the steel workpiece with its brazed reaction material deposit is assembled into a workpiece stack-up with an aluminum workpiece such that the reaction material deposit is positioned between the aluminum workpiece and the steel workpiece at a faying interface of the aluminum and steel workpieces. In yet another step, the reaction material deposit is compressed between the aluminum workpiece and the steel workpiece. In still another step, the reaction material deposit is heated to a temperature above an aluminum-copper eutectic temperature but below a solidus temperature of the aluminum workpiece to form a localized molten phase of intermixed aluminum and copper between the reaction material deposit and the aluminum workpiece. In another step, the localized molten phase of intermixed aluminum and copper is allowed to solidify into an aluminum-copper alloy that establishes a bonding interface with the reaction material deposit and the aluminum workpiece in the form of a primary fusion joint.

The method of the aforementioned embodiment may include further steps or be further defined. For instance, the copper-based reaction material may be pure unalloyed copper or a copper alloy having a minimum copper constituent content of 50 wt %. In particular, the copper alloy may be one of a copper-phosphorus alloy, a copper-silver-phosphorus alloy, a copper-tin-phosphorus alloy, a copper-zinc alloy, an aluminum-bronze alloy, or a silicon-bronze alloy. As another example, the step of depositing the reaction material onto the faying surface of the steel workpiece may involve the use of oscillating wire arc welding to transfer a molten reaction material droplet from a leading tip end of a consumable electrode rod onto the faying surface of the steel workpiece and allowing the molten reaction material droplet to solidify.

The method of the aforementioned embodiment may involve a particular practice of oscillating wire arc welding to deposit the reaction material deposit onto the faying surface of the steel workpiece. To that end, a leading tip end of a consumable electrode rod, which is comprises of the reaction material composition, may be brought into contact with the faying surface of the steel workpiece. An electrical current is then passed through the consumable reaction material electrode rod while the leading tip end of the consumable electrode rod is in contact with the faying surface of the steel workpiece. Next, the consumable electrode rod may be retracted away from the faying surface of the steel workpiece to thereby strike an arc across a gap formed between the consumable electrode rod and the faying surface of the steel workpiece. This arc initiates melting of the leading tip end of the consumable electrode rod. The consumable electrode rod is then protracted forward to close the gap and bring a molten reaction material droplet that has formed at the leading tip end of the electrode rod into contact with the faying surface of the steel workpiece. The contact between the molten reaction material droplet and the faying surface of the steel workpiece extinguishes the arc. Next, the consumable reaction material electrode rod is retracted away from the faying surface of the steel workpiece to transfer the molten reaction material droplet from the leading tip end of the consumable electrode rod to the faying surface of the steel workpiece. The molten reaction material droplet transferred to the faying surface of the steel workpiece eventually solidifies into all or part of the reaction material deposit.

The oscillating wire arc welding just discussed may be repeated one or more times to transfer multiple molten reaction material droplets to the faying surface of the steel workpiece. Those multiple molten reaction material droplets combine and solidify into the reaction material deposit. Moreover, as another variation, the electrical current applied to the consumable electrode rod may be increased when the molten reaction material droplet that has formed at the leading tip end of the electrode rod is in contact with the faying surface of the steel workpiece and the arc has been extinguished. In another variation, the step of compressing the reaction material deposit between the aluminum workpiece and the steel workpiece may be carried out by contacting a first side of the workpiece stack-up with a first electrode and contacting a second side of the workpiece stack-up with a second electrode, and converging the first and second welding electrodes to apply a clamping force against the first and second sides of the workpiece stack-up and to generate a compressive force on the reaction material deposit. In that regard, the step of heating the reaction material deposit may be carried out by passing an electrical current between the first and second welding electrodes and through the reaction material deposit. The electrical current that is passed between the first and second welding electrodes and through the reaction material deposit may be passed at a current level that ranges from 2 kA to 40 kA for a duration of 50 ms to 5000 ms.

The aforementioned embodiment of the disclosed method may produce supplemental bonding between the aluminum and steel workpieces beyond the primary braze and fusion joints. To be sure, the localized molten phase of intermixed aluminum and copper spreads laterally that is formed between the reaction material deposit and the aluminum workpiece may spread beyond the reaction material deposit between the aluminum and steel workpieces to provide a radially extended portion of the aluminum-copper alloy that surrounds the reaction material deposit. This extended portion of the aluminum-copper alloy may establish a secondary braze joint with the steel workpiece and a secondary fusion joint with the aluminum workpiece.

A workpiece stack-up that includes an aluminum workpiece and a steel workpiece joined together may, according to one embodiment, include a steel workpiece, an aluminum workpiece, and a metallurgical joint that secures the steel workpiece and the aluminum workpiece together. The metallurgical joint may comprise a copper-based reaction material that establishes a bonding interface with the steel workpiece in the form of a primary braze joint and further establishes a bonding interface with the aluminum workpiece in the form of a fusion joint through an aluminum-copper alloy. The copper-based reaction material may pure unalloyed copper or a copper alloy having a minimum copper constituent content of 50 wt %. Some specific copper alloys that may be employed include one of a copper-phosphorus alloy, a copper-silver-phosphorus alloy, a copper-tin-phosphorus alloy, a copper-zinc alloy, an aluminum-bronze alloy, or a silicon-bronze alloy. Additionally, in at least some instances, the metallurgical joint may also comprise a radially extended portion of the aluminum-copper alloy that surrounds the reaction material and establishes a secondary braze joint with the steel workpiece and a secondary fusion joint with the aluminum workpiece. The workpiece stack-up may include an additional aluminum workpiece and/or an additional steel workpiece in addition to the aluminum workpiece and the steel workpiece between which the metallurgical joint is formed.

### BRIEF DESCRIPTION OF THE DRAWINGS

FIG. 1 is a cross-sectional illustration of one embodiment of a workpiece stack-up that includes overlapping aluminum and steel workpieces along with a reaction material deposit disposed between faying surfaces of the aluminum and steel workpieces at a joining zone of the stack-up;

FIG. 2 is a cross-sectional illustration of another embodiment of a workpiece stack-up that includes overlapping aluminum and steel workpieces along with a reaction material deposit disposed between faying surfaces of the aluminum and steel workpieces at a joining zone of the stack-up, although here the workpiece stack-up includes an additional aluminum workpiece;

FIG. 3 is a cross-sectional illustration of yet another embodiment of a workpiece stack-up that includes overlapping aluminum and steel workpieces along with a reaction material deposit disposed between faying surfaces of the aluminum and steel workpieces at a joining zone of the stack-up, although here the workpiece stack-up includes an additional steel workpiece;

FIG. 4 is a cross-sectional illustration of a reaction material electrode rod that, during oscillating wire arc welding, has been brought into initial contact with a faying surface of a steel workpiece;

FIG. 5 is a cross-sectional illustration of a reaction material electrode rod that, during oscillating wire arc welding, has been retracted from the faying surface of the steel workpiece, after making initial contact with that surface, to strike an arc;

FIG. 6 is a cross-sectional illustration of a molten droplet of reaction material that, during oscillating wire arc welding, has formed at the tip of the reaction material electrode rod due to the heat generated by the arc;

FIG. 7 is a cross-sectional illustration of the molten reaction material droplet in FIG. 6 being brought into contact with the faying surface of the steel workpiece during oscillating wire arc welding;

FIG. 8 is a cross-sectional illustration of a reaction material deposit after the reaction material electrode rod has left behind a molten reaction material droplet that later solidified;

FIG. 9 is schematic illustration of an apparatus that can perform reaction metallurgical joining on a workpiece stack-up that includes overlapping aluminum and steel workpieces along with a reaction material deposit disposed between faying surfaces of the aluminum and steel workpieces at a joining zone of the stack-up; and

FIG. 10 is a general representative illustration of a metallurgical joint that bonds and secures together the aluminum and steel workpieces within the workpiece stack-up and which includes a bonding interface with each of the overlapping aluminum and steel workpieces.

### DETAILED DESCRIPTION

A method of joining an aluminum workpiece and a steel workpiece through reaction metallurgical joining is disclosed. Reaction metallurgical joining is a process in which a reaction material is heated and compressed between the opposed faying surfaces of the aluminum and steel workpieces to metallurgically join together the two workpiece surfaces. The reaction material is formulated to metallurgically react with the aluminum and the steel included in the aluminum and steel workpieces, respectively, when the reaction material is heated. A copper-based reaction material composition such as, for instance, pure unalloyed copper or a suitable copper alloy, can metallurgically react with both the aluminum and steel workpieces by having the capacity to wet steel on one hand and form a low-melting point eutectic alloy with aluminum on the other hand. Such a reaction material composition can thus form a bonding interface with both steel and aluminum when heated and then subsequently cooled.

The mechanism by which the reaction material interacts with the steel and aluminum to form a bonding interface occurs at different temperatures. Because the aluminum workpiece melts at a significantly lower temperature compared to the steel workpiece, the reaction material is first deposited onto the faying surface of the steel workpiece such that a bonding interface in the form of a primary braze joint is formed between the reaction material and the steel workpiece. Next, the steel workpiece with its adherently brazed reaction material is assembled in stacked relation with the aluminum workpiece such that the reaction material is positioned between the two workpieces at a faying interface. The reaction material is then heated and a compressive force is applied to the workpiece stack-up. The heating and compression causes the reaction material to form a bonding interface with the aluminum workpiece in the form of a primary fusion joint established by an aluminum-copper alloy. Moreover, in some instances, the aluminum-copper alloy may even extend laterally beyond the reaction material to provide additional supplemental bonding between the workpieces in the form of a secondary braze joint along the steel workpiece and a secondary fusion joint along the aluminum workpiece. The primary joints along with the secondary joints, if present, together constitute the overall metallurgical joint that secures the workpieces together.

The deposition of the reaction material onto the faying surface of the steel workpiece is preferably carried out by way of oscillating wire arc welding, although other techniques may certainly be used as well. Oscillating wire arc welding is preferred here since that process can apply the reaction material in a molten state onto the faying surface of the steel workpiece from a consumable electrode rod. In this way, a specified amount of the reaction material can be consistently applied in a particular location, and the size and shape of the brazed-in-place reaction material can be precisely controlled. Moreover, because the reaction material is brazed to the faying surface of the steel workpiece, the oscillating wire arc welding process does not have to be practiced just prior to commencement of the reaction metallurgical joining process. In fact, if desired, the reaction material can be deposited long before the corresponding steel workpiece is expected to undergo reaction metallurgical joining. Such process flexibility even permits the brazed application of the reaction material to be carried out on dedicated equipment completely independent from the reaction metallurgical joining equipment.

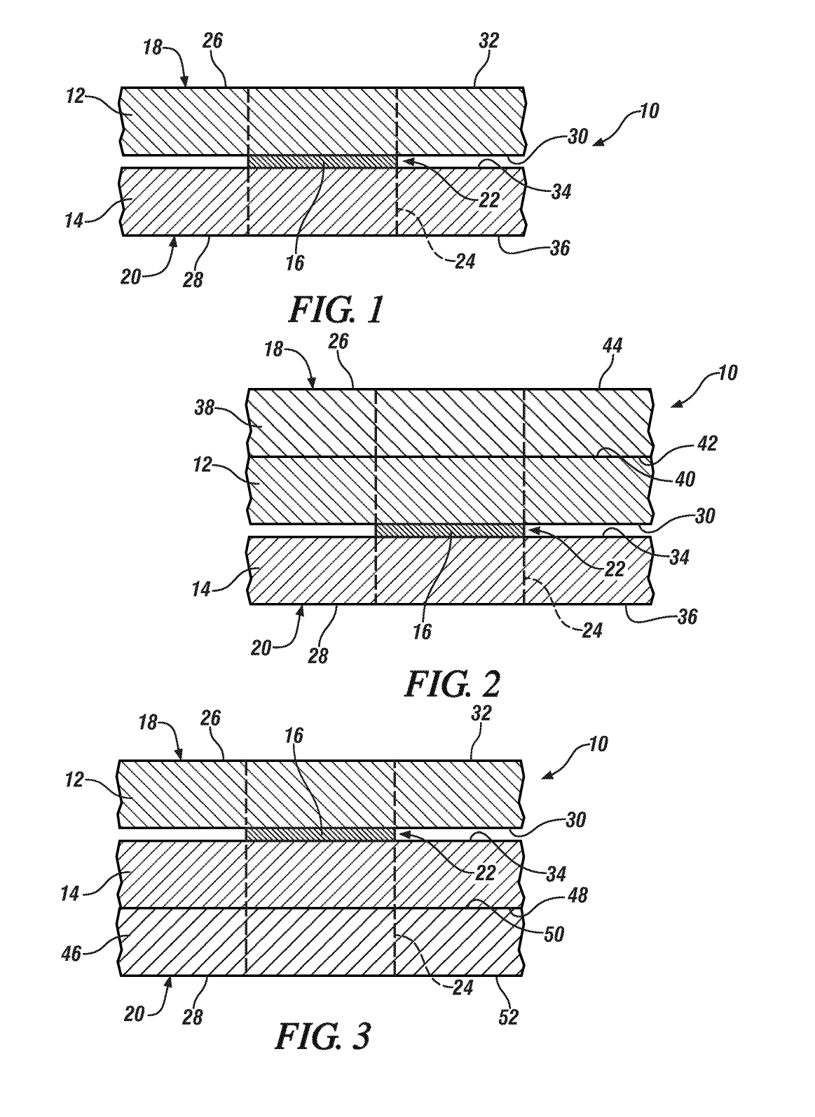

FIGS. 1-10 illustrate an exemplary embodiment of the disclosed method in which a workpiece stack-up 10 that includes an aluminum workpiece 12 and an adjacent overlapping steel workpiece 14 is subjected to reaction metallurgical joining for the purpose of joining the two workpieces 12, 14 together through a reaction material deposit 16. With reference specifically to FIGS. 1-3, the workpiece stack-up 10 has a first side 18 and a second side 20 and includes at least the aluminum and steel workpieces 12, 14 which, as shown, overlap and confront one another to establish a faying interface 22 that encompasses a joining zone 24. The first side 18 of the workpiece stack-up 10 is provided by an aluminum workpiece surface 26 and the second side 20 of the stack-up 10 is provided by a steel workpiece surface 28. The workpiece stack-up 10 may thus be a “2T” stack-up that includes only the adjacent pair of aluminum and steel workpieces 12, 14 (FIG. 1), a “3T” stack-up that includes the adjacent pair of aluminum and steel workpieces 12, 14 plus an additional aluminum workpiece (FIG. 2) or an additional steel workpiece (FIG. 3) so long as the two workpieces of the same base metal composition are disposed next to each other (i.e., aluminum-aluminum-steel or aluminum-steel-steel), or it may include more than three workpieces such as an aluminum-aluminum-steel-steel stack-up, an aluminum-aluminum-aluminum-steel stack-up, or an aluminum-steel-steel-steel stack-up.

The aluminum workpiece 12 includes an aluminum substrate that is either coated or uncoated. The aluminum substrate may be composed of unalloyed aluminum or an aluminum alloy that includes at least 85 wt % aluminum. Some notable aluminum alloys that may constitute the coated or uncoated aluminum substrate are an aluminum-magnesium alloy, an aluminum-silicon alloy, an aluminum-magnesium-silicon alloy, and an aluminum-zinc alloy. If coated, the aluminum substrate may include a refractory oxide surface layer of a refractory oxide material comprised of aluminum oxide compounds and possibly other oxide compounds as well, such as magnesium oxide compounds if, for example, the aluminum substrate is an aluminum-magnesium alloy. Such a refractory oxide material may be a native oxide coating that forms naturally when the aluminum substrate is exposed to air and/or an oxide layer created during exposure of the aluminum substrate to elevated temperatures during manufacture, e.g., a mill scale. The aluminum substrate may also be coated with a layer of zinc, tin, or a metal oxide conversion coating comprised of oxides of titanium, zirconium, chromium, or silicon, as described in US2014/0360986. The surface layer may have a thickness ranging from 1 nm to 10 μm and may be present on each side of the aluminum substrate. Taking into account the thickness of the aluminum substrate and any surface coating that may be present, the aluminum workpiece 12 has a thickness that ranges from 0.3 mm to about 6.0 mm, or more narrowly from 0.5 mm to 3.0 mm, at least at the joining zone 24.

The aluminum substrate of the aluminum workpiece 12 may be provided in wrought or cast form. For example, the aluminum substrate may be composed of a 4xxx, 5xxx, 6xxx, or 7xxx series wrought aluminum alloy sheet layer, extrusion, forging, or other worked article. Alternatively, the aluminum substrate may be composed of a 4xx.x, 5xx.x, 6xx.x, or 7xx.x series aluminum alloy casting. Some more specific kinds of aluminum alloys that may constitute the aluminum substrate include, but are not limited to, AA5754 and AA5182 aluminum-magnesium alloy, AA6111 and AA6022 aluminum-magnesium-silicon alloy, AA7003 and AA7055 aluminum-zinc alloy, and Al-10Si-Mg aluminum die casting alloy. The aluminum substrate may further be employed in a variety of tempers including annealed (O), strain hardened (H), and solution heat treated (T), if desired. The term “aluminum workpiece” as used herein thus encompasses unalloyed aluminum and a wide variety of aluminum alloys, whether coated or uncoated, in different spot-weldable forms including wrought sheet layers, extrusions, forgings, etc., as well as castings.

The steel workpiece 14 includes a steel substrate from any of a wide variety of strengths and grades that is either coated or uncoated. The steel substrate may be hot-rolled or cold-rolled and may be composed of steel such as mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel as is typically used in the production of press-hardened steel (PHS). Preferred compositions of the steel substrate, however, include mild steel, dual phase steel, and boron steel used in the manufacture of press-hardened steel. Those three types of steel have ultimate tensile strengths that, respectively, range from 150 MPa to 500 MPa, from 500 MPa to 1100 MPa, and from 1200 MPa to 1800 MPa.

The steel substrate, if coated, preferably includes a surface layer of zinc (galvanized), a zinc-iron alloy (galvanneal), an electrodeposited zinc-iron alloy, a zinc-nickel alloy, nickel, aluminum, an aluminum-magnesium alloy, an aluminum-zinc alloy, or an aluminum-silicon alloy, any of which may have a thickness of up to 50 μm and may be present on each side of the steel substrate. Taking into account the thickness of the steel substrate and any surface coating that may be present, the steel workpiece 14 has a thickness that ranges from 0.3 mm and 6.0 mm, or more narrowly from 0.6 mm to 2.5 mm, at least at the joining site 24. The term “steel workpiece” as used herein thus encompasses a wide variety of spot-weldable steels, whether coated or uncoated, of different strengths and grades.

When the aluminum and steel workpieces 12, 14 are stacked-up for spot welding in the context of a “2T” stack-up embodiment, which is illustrated in FIG. 1, the aluminum workpiece 12 and the steel workpiece 14 present the first and second sides 18, 20 of the workpiece stack-up 10, respectively. In particular, the aluminum workpiece 12 includes a faying surface 30 and an exposed back surface 32 and, likewise, the steel workpiece 14 includes a faying surface 34 and an exposed back surface 36. The faying surfaces 30, 34 of the two workpieces 12, 14 overlap and confront one another to establish the faying interface 22 that extends through the joining zone 24. The exposed back surfaces 32, 36 of the aluminum and steel workpieces 12, 14, on the other hand, face away from one another in opposite directions at the joining zone 24 and constitute, respectively, the aluminum workpiece surface 26 and the steel workpiece surface 28 that provide the first and second sides 18, 20 of the workpiece stack-up 10.

The term “faying interface 22” is used broadly in the present disclosure and is intended to encompass any overlapping and confronting relationship between the faying surfaces 30, 34 of the aluminum and steel workpieces 12, 14 in which reaction metallurgical joining can be practiced through the reaction material deposit 16. Each of the faying surfaces 30, 34 may, for example, be in direct contact with the reaction material deposit 16 within the joining zone 24. As another example, the faying surface 30 of the aluminum workpiece 12 may be in indirect contact with the reaction material deposit 16 such as when the faying surface 30 is separated from the reaction material deposit 16 by an intervening organic material layer such as a heat-curable adhesive or sealer. This type of indirect contact between the faying surface 30 of the aluminum workpiece 12 and the reaction material deposit 16 can result, for example, when an adhesive layer (not shown) is applied over one or both of the faying surfaces 30, 34 before the workpieces 12, 14 are stacked against each other to assemble the workpiece stack-up 10. Any such adhesive layer will be laterally displaced from the joining zone 24 and any residual from that layer will be thermally decomposed during the reaction metallurgical joining process so as not to interfere with the formation of the overall metallurgical joint that ultimately secures the workpieces 12, 14 together.

An adhesive layer that may be present between the faying surfaces 30, 34 of the aluminum and steel workpieces 12, 14 is one that preferably includes a structural thermosetting adhesive matrix. The structural thermosetting adhesive matrix may be any curable structural adhesive including, for example, as a heat curable epoxy or a heat curable polyurethane. Some specific examples of heat-curable structural adhesives that may be used as the adhesive matrix include DOW Betamate 1486, Henkel Terokal 5089, and Uniseal 2343, all of which are commercially available. Additionally, the adhesive layer may further include optional filler particles, such as fumed silica particles, dispersed throughout the thermosetting adhesive matrix to modify the viscosity profile or other properties of the adhesive layer for manufacturing operations. The adhesive layer, if present, preferably has a thickness of 0.1 mm to 2.0 mm and is typically intended to provide additional bonding between the workpieces 12, 14 outside of the joining zone 24 upon being cured in an ELPO-bake oven or other heating apparatus following the reaction metallurgical joining process.

Of course, as shown in FIGS. 2-3, the workpiece stack-up 10 is not limited to the inclusion of only the aluminum workpiece 12 and the adjacent steel workpiece 14. The workpiece stack-up 10 may also include at least an additional aluminum workpiece or at least an additional steel workpiece—in addition to the adjacent pair of aluminum and steel workpieces 12, 14—so long as the additional workpiece(s) are disposed adjacent to the workpiece 12, 14 of the same base metal composition; that is, any additional aluminum workpiece(s) are disposed adjacent to the aluminum workpiece 12 and any additional steel workpiece(s) are disposed adjacent to the steel workpiece 14. As for the characteristics of the additional workpiece(s), the descriptions of the aluminum workpiece 12 and the steel workpiece 14 provided above are applicable to any additional aluminum or steel workpiece that may be included in the workpiece stack-up 10. It should be noted, though, that while the same general descriptions apply, there is no requirement that the multiple aluminum workpieces or the multiple steel workpieces of the workpiece stack-up 10 be identical in terms of composition, thickness, or form (e.g., wrought or cast).

As shown in FIG. 2, for example, the workpiece stack-up 10 may include the adjacent pair of aluminum and steel workpieces 12, 14 described above along with an additional aluminum workpiece 38. Here, as shown, the additional aluminum workpiece 38 overlaps the pair of aluminum and steel workpieces 12, 14 and lies adjacent to the aluminum workpiece 12. When the additional aluminum workpiece 38 is so positioned, the exposed back surface 36 of the steel workpiece 14 constitutes the steel workpiece surface 28 that provides the second side 20 of the workpiece stack-up 10, as before, while the aluminum workpiece 12 that lies adjacent to the steel workpiece 14 now includes a pair of opposed faying surfaces 30, 40. The faying surface 30 of the aluminum workpiece 12 that faces the steel workpiece 14 continues to establish the faying interface 22 through the reaction material deposit 16 along with the confronting faying surface 34 of the steel workpiece 14 as previously described. The other faying surface 40 of the aluminum workpiece 12 overlaps and confronts a faying surface 42 of the additional aluminum workpiece 38. As such, in this particular arrangement of lapped workpieces 38, 12, 14, an exposed back surface 44 of the additional aluminum workpiece 38 now constitutes the aluminum workpiece surface 26 that provides the first side 18 of the workpiece stack-up 10.

In another example, as shown in FIG. 3, the workpiece stack-up 10 may include the adjacent pair aluminum and steel workpieces 12, 14 described above along with an additional steel workpiece 46. Here, as shown, the additional steel workpiece 46 overlaps the pair of aluminum and steel workpieces 12, 14 and lies adjacent to the steel workpiece 14. When the additional steel workpiece 46 is so positioned, the exposed back surface 32 of the aluminum workpiece 12 constitutes the aluminum workpiece surface 26 that provides the first side 18 of the workpiece stack-up 10, as before, while the steel workpiece 14 that lies adjacent to the aluminum workpiece 12 now includes a pair of opposed faying surfaces 34, 48. The faying surface 34 of the steel workpiece 14 that faces the aluminum workpiece 12 continues to establish the faying interface 22 through the reaction material deposit 16 along with the confronting faying surface 30 of the aluminum workpiece 12 as previously described. The other faying surface 48 of the steel workpiece 14 overlaps and confronts a faying surface 50 of the additional steel workpiece 46. As such, in this particular arrangement of lapped workpieces 12, 14, 46, an exposed back surface 52 of the additional steel workpiece 46 now constitutes the steel workpiece surface 28 that provides the second side 20 of the workpiece stack-up 10.

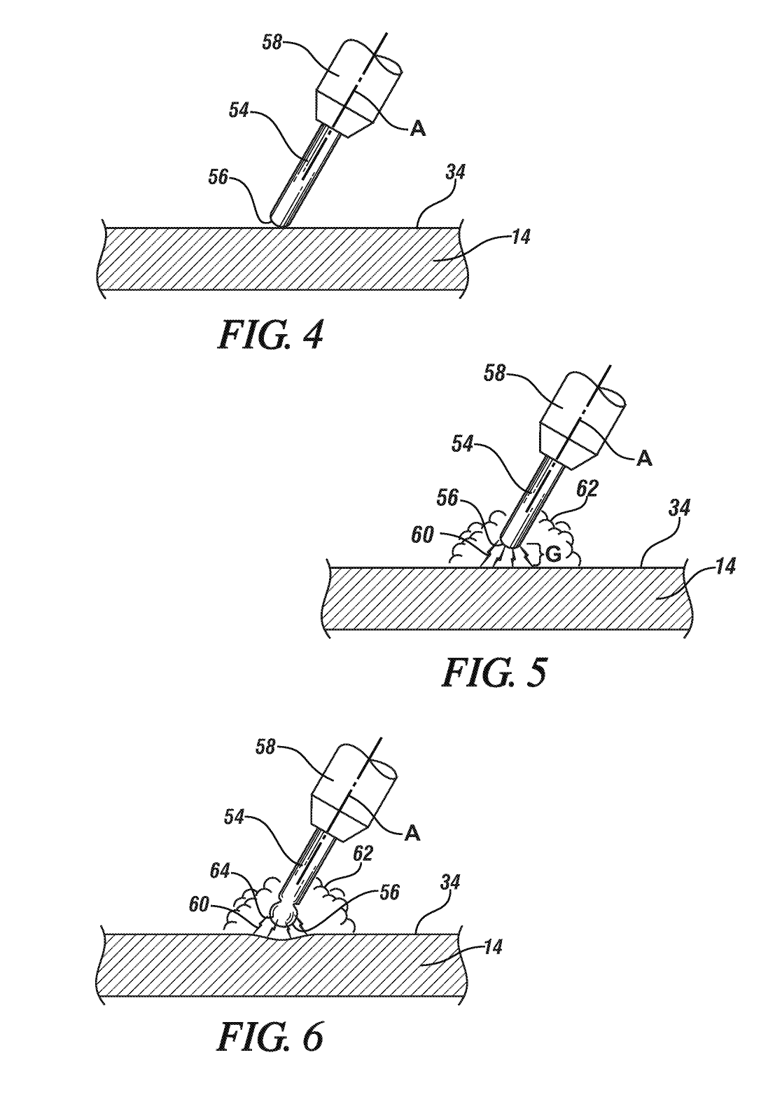

Turning now to FIGS. 4-10, the various stages of the disclosed method of subjecting the workpiece stack-up 10 to reaction metallurgical joining so as to join together the pair of adjacent aluminum and steel workpieces 12, 14 at the joining zone 24 are shown. First, a reaction material composition is deposited onto the faying surface 34 of the steel workpiece 14 using an oscillating wire arc welding process, which results in the reaction material deposit 16 (FIGS. 1-3 and 8) being adherently brazed to the faying surface 34. Second, the aluminum and steel workpieces 12, 14 are assembled into the workpiece stack-up 10 (examples of which are shown in FIGS. 1-3) to establish the faying interface 22 with the reaction material deposit 16 situated between the opposed faying surfaces 30, 34 of the aluminum and steel workpieces 12, 14. And third, the aluminum and steel workpieces 12, 14 are metallurgically joined together at the joining zone 24 through the practice of reaction metallurgical joining. It should be noted that while the workpiece stack-up 10 shown in FIG. 9 depicts only the adjacent pair of aluminum and steel workpieces 12, 14, the accompanying description applies equally to circumstances in which the stack-up 10 includes at least an additional aluminum or at least an additional steel workpiece.

The pre-placement of the reaction material deposit 16 onto the steel workpiece 14 is illustrated in FIGS. 4-8. To carry out this stage of the disclosed method, the reaction material composition that constitutes the reaction material deposit 16 is initially packaged in the form of a consumable reaction material electrode rod 54 that has a leading tip end 56. The reaction material electrode rod 54 protrudes from a guide nozzle 58 and is reciprocally moveable along its longitudinal axis A. The reaction material electrode rod 54 is also connected to a welding power supply (not shown) by an electrode cable. Likewise, to complete the arc welding circuit, the steel workpiece 14 is connected to the welding power supply by a work cable. The welding power supply may be constructed to deliver a direct current (DC) or an alternating current (AC) of sufficient strength through the reaction material electrode rod 54, which may be assigned either a negative polarity or a positive polarity, so that an arc can be struck between the reaction material electrode rod 54 and the faying surface 34 of the steel workpiece 14 as will be further described below.

The reaction material composition incorporated into the reaction material electrode rod 54 may be a copper-based reaction material composition since copper can readily wet steel and also form a relatively low-melting point eutectic (˜542° C.) with aluminum. For example, the reaction material composition may be pure unalloyed copper that meets the ASTM/UNS designations C10100, C11000, or C13000. In other examples, the reaction material composition may be a copper alloy with a minimum copper constituent content of 50 wt %. A sampling of suitable copper alloys includes a copper-phosphorus alloy, a copper-silver-phosphorus alloy, a copper-tin-phosphorus alloy, a copper-zinc alloy (i.e., brass), an aluminum-bronze alloy, or a silicon-bronze alloy. Some of these copper alloys—in particular a copper-phosphorus alloy and a copper-silver-phosphorus alloy—are self-fluxing and would therefore help remove oxide remnants from the faying surface 30 of the aluminum workpiece 12 if melted in that vicinity. Copper-phosphorus and copper-silver-phosphorus alloys derive their self-fluxing nature from the high affinity that phosphorus has for oxygen.

Referring still to FIG. 4, the early phase of oscillating wire arc welding includes protracting the reaction material electrode rod 54 along its longitudinal axis A to bring the tip end 56 into contact with the faying surface 34 of the steel workpiece 14. The longitudinal axis A of the reaction material rod 54 may be oriented normal to the faying surface 34 or, as shown, it may be inclined at an angle to facilitate access to the faying surface 34. Once the tip end 56 of the reaction material electrode rod 54 makes contact with the faying surface 34, the welding power supply is turned on and an electrical current is applied and passed through the electrode rod 54. The amount of electrical current passed through the rod 54 depends on the reaction material composition and the diameter of the rod 54. For example, when the reaction material rod 54 has a diameter of 1.0 mm, the current passed through the rod typically ranges from 20 A to 250 A for the wide variety of the possible copper-based reaction material compositions listed above.

After contact is established between the tip end 56 and the faying surface 34 and current is flowing, the reaction material electrode rod 54 is retracted from the faying surface 34 of the steel workpiece 14 along its longitudinal axis A, as shown in FIG. 5, typically to a pre-set distance away from the faying surface 34. The retraction of the reaction material electrode rod 54 results in the tip end 56 of the rod 54 being displaced from the faying surface 34 by a gap G that is initially equal to the pre-set retraction distance. The ensuing electrical potential difference between the separated parts causes an arc 60 to be struck across the gap G and between the tip end 56 of the rod 54 and the faying surface 34 of the steel workpiece 14. The arc 60 heats the tip end 56 and initiates melting of the reaction material electrode rod 54 at that location. A shielding gas—usually comprised of argon, helium, carbon dioxide, or mixtures thereof—may be directed at the steel workpiece 14 to provide for a stable arc 60 and to establish a protective zone 62 that prevents atmospheric oxygen from contaminating the molten portion of the reaction material electrode rod 54.

The melting of the reaction material electrode rod 54 by the arc 60 causes a molten reaction material droplet 64 to collect at the tip end 56 of the electrode rod 54, as depicted in FIG. 6. This droplet 64, which is retained by surface tension, grows in volume and becomes further displaced from the faying surface 34 of the steel workpiece 14 after the rod 54 has been retracted to its pre-set distance as a result of the reaction material electrode rod 54 being consumed and the leading tip end 56 receding up the longitudinal axis A of the rod 54. The size of the gap G thus increases as the arc 60 melts and consumes the reaction material electrode rod 54 so as to grow the molten reaction material droplet 64. Indeed, during the time the molten reaction material droplet 64 is being grown, the reaction material electrode rod 54 may be held stationary or it may be protracted towards the faying surface 34 at a slower rate than the rate at which the electrode rod 54 is being consumed up its longitudinal axis A in order to afford some control over the growth rate of the molten reaction material droplet 64 and the rate at which the gap G is increasing.

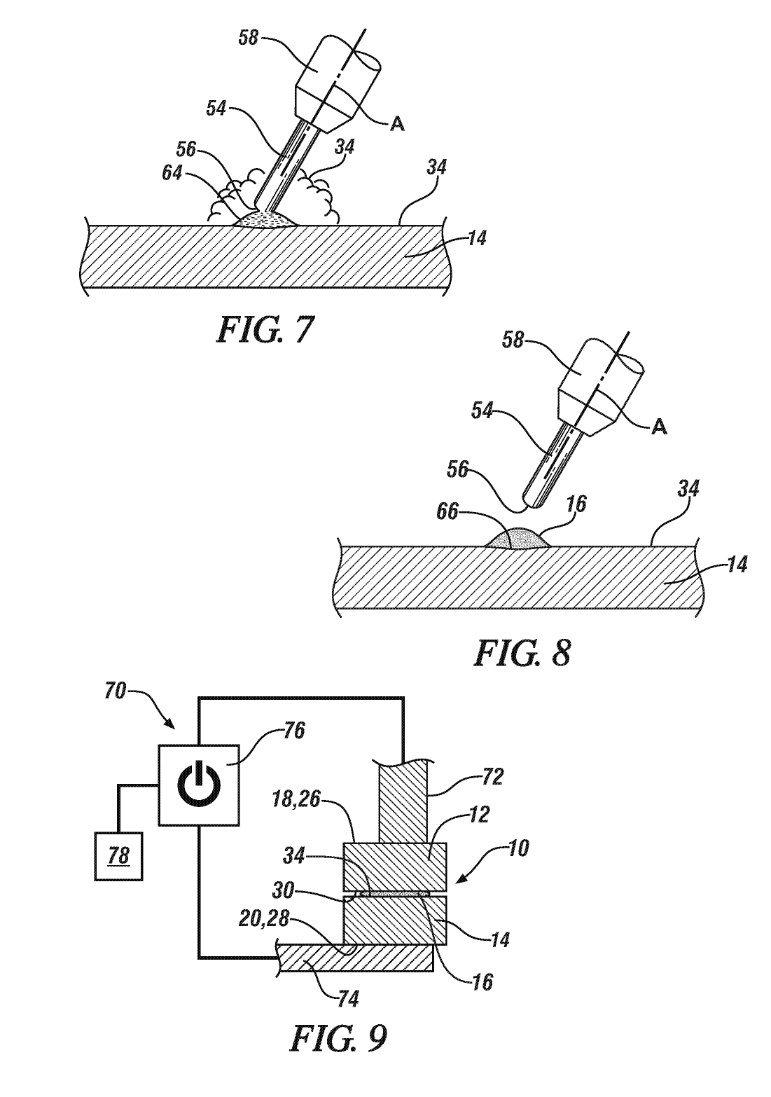

Once the molten reaction material droplet 64 has formed and attained a desired volume, the electrode material rod 54 is protracted along its longitudinal axis A to bring the molten material droplet 64 into contact with the faying surface 34 of the steel workpiece 14, as shown in FIG. 7. The convergence of the molten reaction material droplet 64 and the faying surface 34 of the steel workpiece 14 as a result of the forward protracting movement of the rod 54 extinguishes the arc 60, at which point the current applied from the welding power supply may be increased by 125% to 150%. The contacting molten reaction material droplet 64 wets the faying surface 36 of the steel workpiece 14 but typically does not cause localized melting of the steel workpiece 14 since it is not hot enough. After the molten reaction material droplet 64 has been brought into contact with the faying surface 34 of the steel workpiece 14, and the applied current increased, the reaction material electrode rod 54 is once again retracted along its longitudinal axis A, as shown in FIG. 8 (showing the reaction material deposit 16 after the molten reaction material droplet 64 has solidified).

The retraction of the electrode rod 54 away from the faying surface 34 transfers the molten reaction material droplet 64 to the faying surface 34 of the steel workpiece 14. Such detachment and transfer of the molten reaction material droplet 64 is believed to be aided in part by the increase in the applied current after the droplet 64 is brought into contact with the faying surface 34. That is, the 125% to 150% increase in the applied current helps detach the molten reaction material droplet 64 by ensuring that any surface tension that may be acting to hold the molten reaction material droplet 64 onto the electrode material rod 54 is overcome. The transfer of the molten reaction material droplet 64 to the faying surface 34 through a single cycle of oscillating wire arc welding, as just described, may be sufficient in some circumstances from a size, shape, and quantity standpoint. In other circumstances, however, it may be desirable to carry out one or more additional oscillating wire arc welding cycles. Performing one or more additional oscillating wire arc welding cycles allows various aspects of the molten reaction material droplet 64 to be managed such as the volume, shape, and internal consistency of the transferred molten reaction material droplet 64.

In one embodiment, for example, after the reaction material electrode rod 54 is retracted from the faying surface 34 of the steel workpiece 14 and the molten reaction material droplet 64 is transferred, thus completing the first oscillating wire arc welding cycle, a second oscillating wire arc welding cycle may be performed. In particular, the applied current provided by the welding power supply may be returned to its initial level and an arc 60 may once again be struck across the gap G between the tip end 56 of the reaction material electrode rod 54 and the faying surface 34 (which now includes the applied reaction material droplet). The resultant heating of the reaction material electrode rod 54 causes another molten reaction material droplet 64 to collect at the tip end 56 of the electrode rod 54. The reaction material electrode rod 54 is then protracted along its axis A to join the molten reaction material droplet 64 held by the tip end 56 of the electrode rod 54 with the molten reaction material droplet already on the faying surface 34 of the steel workpiece 14. The reaction material electrode rod 54 may then be retracted along its longitudinal axis A with an increased applied current level (e.g., 125% to 150%) to facilitate transfer of the second molten reaction material droplet 64, which completes the second oscillating wire arc welding cycle. Multiple additional cycles may be carried out in the same way.

The molten reaction material that is transferred from the reaction material electrode rod 54 to the faying surface 34—through one or multiple oscillating wire arc welding cycles—eventually solidifies into the reaction material deposit 16, as illustrated in FIG. 8. The reaction material deposit 16 is bonded to the faying surface 34 of the steel workpiece 14 by way of a primary braze joint 66 since the molten reaction material droplet 64 had the capacity to wet the underlying faying surface 34 of the steel workpiece 14 prior to being solidified. The reaction material deposit 16 can assume a wide variety of sizes and shapes. To be sure, the reaction material deposit may have a hemispherical or rectangular cross-sectional profile, as well as others, and it may have a height of 0.1 mm to 1.0 mm and a base diameter of 0.5 mm to 4.0 mm. Moreover, depending on the size and shape of the reaction material deposit 16, and the specifics of the workpiece stack-up 10, multiple reaction material deposits 16 may be present at within the joining zone 24 despite the fact that only a single representative reaction material deposit 16 is shown generally in the Figures.

The steel workpiece 14 is now ready for reaction metallurgical joining (sometimes referred to hereafter as “RMJ”) as part of joining the workpiece stack-up 10. Referring now to FIG. 9, the steel workpiece 14, which supports the adhered reaction material deposit 16 on its faying surface 34, is facially aligned with the aluminum workpiece 12 and assembled into the workpiece stack-up 10 along with, optionally, at least an additional aluminum workpiece or at least an additional steel workpiece, as described above. The workpiece stack-up 10 is then brought to a RMJ apparatus 70 that can provide the necessary heat and compression at the joining zone 24 of the stack-up 10 to carry out the reaction metallurgical joining process. The apparatus 70 may include a first electrode 72, a second electrode 74, a power source 76, and a controller 78, as shown schematically in FIG. 9. A resistance spot welding gun and related ancillary equipment can serve adequately as the RMJ apparatus 70, if desired.

The first and second electrodes 72, 74 are each constructed from an electrically conductive material such as a copper alloy including, for instance, a zirconium copper alloy (ZrCu) that contains 0.10 wt % to 0.20 wt % zirconium and the balance copper, a copper-chromium alloy (CuCr) that includes 0.6 wt % to 1.2 wt % chromium and the balance copper, or a copper-chromium-zirconium alloy (CuCrZr) that includes 0.5 wt % to 1.5 wt % chromium, 0.02 wt % to 0.20 wt % zirconium, and the balance copper. The first and second electrodes may also be constructed from a dispersion strengthened copper material such as copper with an aluminum oxide dispersion or a more resistive refractory metal composite such as a tungsten-copper composite. The two electrodes 72, 74 are electrically coupled to the power source 76 and are electrically and mechanically configured within the RMJ apparatus to pass an electrical current, preferably a DC current, through the workpiece stack-up 10 at the joining zone 24. The power supply 76 that supplies the electrical current may be a medium-frequency direct current (MFDC) inverter power supply that includes an inverter and a MFDC transformer. A MFDC transformer can be obtained commercially from a number of suppliers including Roman Manufacturing (Grand Rapids, Mich.), ARO Welding Technologies (Chesterfield Township, Mich.), and Bosch Rexroth (Charlotte, N.C.). The controller 78 interfaces with the power supply 76 and can be programmed to control the characteristics of the electrical current being exchanged between the electrodes 72, 74. For instance, the controller 78 can be programmed to administer passage of the electrical current at a constant current level or as a series of current pulses, among other options.

The workpiece stack-up 10 is positioned between the first and second electrodes 72, 74 such that the first electrode 72 confronts the aluminum workpiece surface 26 of the first side 18 of the workpiece stack-up 10 and the second electrode 74 confronts the steel workpiece surface 28 of the second side 20 of the stack-up 10. The first and second electrodes 72, 74 are then brought into contact with their respective sides 18, 20 of the workpiece stack-up 10 at the joining zone 24. A weld gun or other mechanical apparatus that carries the electrodes 72, 74 is operated to clamp or converge the two electrodes 72, 74 (either one or both of the electrodes 72, 74 being mechanically moveable) to apply a clamping force against the sides 18, 20 of the workpiece stack-up 10 at the joining zone 24 through the application of pressure by the first and second electrodes 72, 74. This generates a compressive force on the reaction material deposit 16. The imposed clamping force preferably ranges from 400 lb (pounds force) to 2000 lb or, more narrowly, from 600 lb to 1300 lb. And, to help establish good mechanical, electrical, and thermal contact at the aluminum workpiece surface 26, especially if a surface layer of a refractory oxide material is present, the contacting weld face portion of the first electrode 72 may include a series of upstanding circular ridges or a series of recessed grooves that surround a central axis of the weld face portion.

After the electrodes 72, 74 are in position against the workpiece stack-up 10 and a clamping force is applied, an electrical current is passed between the electrodes 72, 74 and through the stack-up 10 at the joining site 16. This electrical current passes through the reaction material deposit 16 located at the faying interface 22 of the confronting faying surfaces 30, 34 of the aluminum and steel workpiece 12, 14. The flow of current through the reaction material deposit 16 is controlled by the controller 78 to heat the reaction material deposit 16 to a temperature above the aluminum-copper eutectic temperature, which is approximately 548° C., but below the solidus temperature of the base aluminum substrate of the aluminum workpiece 12, which typically lies somewhere between 570° C. and 640° C. depending on the composition of the aluminum substrate. While the characteristics of the electrical current exchanged between the electrodes 72, 74 and passed through the reaction material deposit 16 can vary, in many instances the electrical current is passed at a current level that ranges from 2 kA to 40 kA for a duration of 50 ms to 5000 ms.

Upon being heating to above the aluminum-copper eutectic temperature, the reaction material deposit 16 and the adjacent faying surface 30 of the aluminum workpiece 12 contribute to the formation of a localized molten phase comprised of intermixed aluminum and copper derived from coalescence of the copper from the reaction material deposit 16 and aluminum from the aluminum workpiece 12. The localized molten phase of intermixed aluminum and copper establishes a transition between the solid portions of the reaction material deposit 16 and the aluminum workpiece 12 and, in some instances, may spread laterally beyond the reaction material deposit 16 along the faying interface 22 and between the faying surfaces 30, 34 of the aluminum and steel workpieces 12, 14. This localized molten phase initially includes approximately 67 wt % aluminum and approximately 33 wt % copper given that such a ratio of aluminum:copper corresponds to the aluminum-copper eutectic temperature, although the aluminum and copper content ultimately attained in the localized molten phase over time may vary from the eutectic Al:Cu ratio depending on the temperature to which the reaction material deposit 16 is heated. Additionally, in some embodiments, such as when the reaction material deposit 16 is composed of a Cu—Ag—P reaction material composition, the formation of the localized molten phase of intermixed aluminum and copper may be self-fluxing.

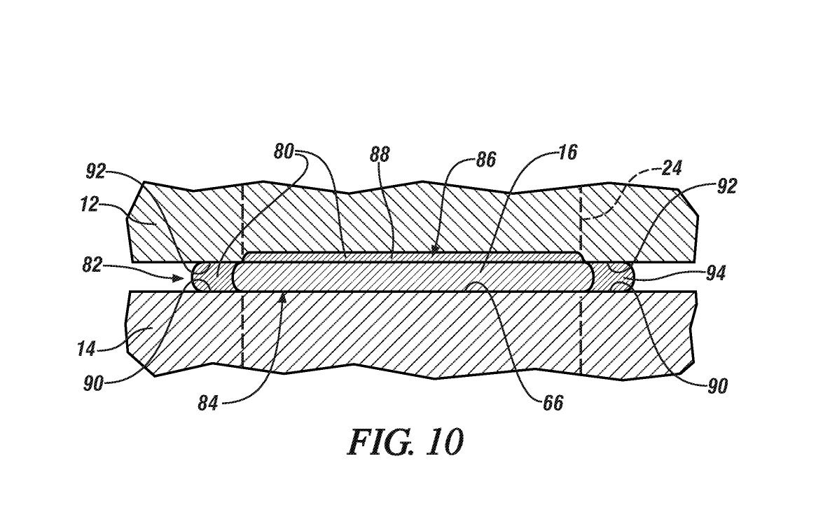

The electrical current being passed between the electrodes 72, 74 and through the reaction material deposit 16 is ceased after the localized molten phase of intermixed aluminum and copper has formed due to an interaction at the interface of the reaction material deposit 16 and the aluminum workpiece 12. The disruption of current flow through the reaction material deposit 16 causes the localized molten phase of intermixed aluminum and copper to cool and solidify into an aluminum-copper alloy 80 (FIG. 10). The aluminum-copper alloy 80 secures the reaction material deposit 16 to the aluminum workpiece 12 by way of a fusion joint and, if the molten phase of intermixed aluminum and copper has spread laterally beyond the deposit 16, it may establish secondary fusion and braze joints with the aluminum and steel workpieces 12, 14, respectively, outside of the reaction material deposit 16.

The reaction metallurgical joining process completes the formation of a metallurgical joint 82 that secures the aluminum and steel workpieces 12, 14 together within the workpiece stack-up 10, as shown in the general representative illustration of FIG. 10. Indeed, as shown in FIG. 10, the metallurgical joint 82 is the product of, at a minimum, a bonding interface 84 between the reaction material deposit 16 and the steel workpiece 14, and a bonding interface 86 between the reaction material deposit 16 and the aluminum workpiece 12. The bonding interface 84 between the reaction material deposit 16 and the steel workpiece 14 is provided by the primary braze joint 66 established in advance of subjecting the workpiece stack-up 10 to reaction metallurgical joining. Subsequent to the formation of the primary braze joint 66, the bonding interface 86 between the reaction material deposit 16 and the aluminum workpiece 12 is provided by a primary fusion joint 88 established by the aluminum-copper alloy 80. These two bonding interfaces 84, 86 of the metallurgical joint 82 have a variety of noteworthy structural traits including the fact that a hard and brittle Fe—Al intermetallic layer is not present at or in the vicinity of either interface 84, 86. The absence of a Fe—Al intermetallic layer can help the metallurgical joint 82 avoid interfacial fracture at one or both of the bonding interfaces 84, 86 when the joint is subjected to loading.

In addition to the primary braze and fusion joints 66, 88 that provide the bonding interfaces 84, 86 between the reaction material deposit 16 and the steel and aluminum workpieces 12, 14, the aluminum-copper alloy 80 may optionally provide supplemental bonding between the aluminum and steel workpieces 12, 14 outside of and around the reaction material deposit 16. In this way, the metallurgical joint 82 may optionally include a secondary braze joint 90 and a secondary fusion joint 92, each of which is provided by a radially extended portion 94 of aluminum-copper alloy 80 that surrounds the reaction material deposit 16 along the faying interface 22. In particular, the extended portion 94 of the aluminum-copper alloy 80 establishes the secondary braze joint 90 with the steel workpiece 14 since the molten phase of intermixed aluminum and copper wets, but does not melt, the faying surface 34 of the steel workpiece 14 when it spreads laterally along the faying interface 22 during reaction metallurgical joining. Moreover, the extended portion 94 of the aluminum-copper alloy 80 establishes the secondary fusion joint 92 with the aluminum workpiece 12 in the same way as the primary fusion joint 88. The secondary braze and fusion joints 90, 92, if present, are part of the overall metallurgical joint 82 that secures the aluminum and steel workpieces 12, 14 together.

The imposed clamping pressure applied on the workpiece stack-up 10 at the joining zone 24 by the opposed electrodes 72, 74 is released and the electrodes 72, 74 are retracted away from their respective sides 18, 20 of the workpiece stack-up 10 following formation of the molten phase of intermixed aluminum and copper. Preferably, the clamping pressure is relieved after the molten phase of intermixed aluminum and copper has fully solidified into the aluminum-copper alloy 80 in order to help ensure that the alloy 80 is formed under pressure. The process detailed above and described with respect to FIGS. 4-10 may then be repeated at one or more additional joining zones 24 on the same workpiece stack-up 10, if needed, or a new workpiece 10. The RMJ process may be used exclusively to secure the aluminum and steel workpieces 12, 14 within the workpiece stack-up 10 together by one or a series of the metallurgical joints 82 or it may be used in conjunction with other joining techniques including resistance spot welding and mechanical fastening.

The above description of preferred exemplary embodiments is merely descriptive in nature; they are not intended to limit the scope of the claims that follow. Each of the terms used in the appended claims should be given its ordinary and customary meaning unless specifically and unambiguously stated otherwise in the specification.

1. A method of joining an aluminum workpiece and an adjacent overlapping steel workpiece by reaction metallurgical joining, the method comprising:
assembling a workpiece stack-up that includes an aluminum workpiece, a steel workpiece, and a reaction material located between the aluminum workpiece and the steel workpiece at a faying interface of the aluminum and steel workpieces;
compressing the reaction material between the aluminum workpiece and the steel workpiece;
heating the reaction material momentarily to form a metallurgical joint between the aluminum workpiece and the steel workpiece, the metallurgical joint comprising a bonding interface between the reaction material and the steel workpiece and a bonding interface between the reaction material and the aluminum workpiece, and wherein a Fe—Al intermetallic layer is not present at either of the bonding interface between the reaction material and the steel workpiece or the bonding interface between the reaction material and the aluminum workpiece.

2. The method set forth in claim 1, wherein the reaction material is comprised of a copper-based reaction material composition that has the capacity to both wet steel and form a low-melting point eutectic alloy with aluminum.

3. The method set forth in claim 2, wherein the copper-based reaction material is pure unalloyed copper or a copper alloy having a minimum copper constituent content of 50 wt %, the copper alloy being one of a copper-phosphorus alloy, a copper-silver-phosphorus alloy, a copper-tin-phosphorus alloy, a copper-zinc alloy, an aluminum-bronze alloy, or a silicon-bronze alloy.

4. The method set forth in claim 1, wherein the bonding interface between the reaction material and the steel workpiece is a primary braze joint and wherein the bonding interface between the reaction material and the aluminum workpiece is a primary fusion joint established by an aluminum-copper alloy.

5. The method set forth in claim 4, wherein the metallurgical joint further comprises a radially extended portion of the aluminum-copper alloy that surrounds the reaction material and establishes a secondary braze joint with the steel workpiece and a secondary fusion joint with the aluminum workpiece.

6. The method set forth in claim 1, wherein the workpiece stack-up includes an additional aluminum workpiece and/or an additional steel workpiece in addition to the aluminum workpiece and the steel workpiece between which the metallurgical joint is formed.

7. A method of joining an aluminum workpiece and an adjacent overlapping steel workpiece by reaction metallurgical joining, the method comprising:
depositing a reaction material comprised of a copper-based reaction material composition onto a faying surface of a steel workpiece to form a reaction material deposit, the reaction material deposit establishing a bonding interface with the faying surface of the steel workpiece in the form of a primary braze joint;
assembling the steel workpiece with its brazed reaction material deposit into a workpiece stack-up with an aluminum workpiece such that the reaction material deposit is positioned between the aluminum workpiece and the steel workpiece at a faying interface of the aluminum and steel workpieces;
compressing the reaction material deposit between the aluminum workpiece and the steel workpiece;
heating the reaction material deposit to a temperature above an aluminum-copper eutectic temperature but below a solidus temperature of the aluminum workpiece to form a localized molten phase of intermixed aluminum and copper between the reaction material deposit and the aluminum workpiece; and
allowing the localized molten phase of intermixed aluminum and copper to solidify into an aluminum-copper alloy that establishes a bonding interface with the reaction material deposit and the aluminum workpiece in the form of a primary fusion joint.

8. The method set forth in claim 7, wherein the copper-based reaction material is pure unalloyed copper or a copper alloy having a minimum copper constituent content of 50 wt %, the copper alloy being one of a copper-phosphorus alloy, a copper-silver-phosphorus alloy, a copper-tin-phosphorus alloy, a copper-zinc alloy, an aluminum-bronze alloy, or a silicon-bronze alloy.

9. The method set forth in claim 7, wherein depositing a reaction material comprised of a copper-based reaction material composition onto a faying surface of a steel workpiece comprises:
using oscillating wire arc welding to transfer a molten reaction material droplet from a leading tip end of a consumable electrode rod onto the faying surface of the steel workpiece and allowing the molten reaction material droplet to solidify.

10. The method set forth in claim 8, wherein depositing a reaction material comprised of a copper-based reaction material composition onto a faying surface of a steel workpiece comprises:
(a) bringing a leading tip end of a consumable electrode rod, which is comprised of the reaction material composition, into contact with the faying surface of the steel workpiece;
(b) passing an electrical current through the consumable electrode rod while the leading tip end of the consumable electrode rod is in contact with the faying surface of the steel workpiece;
(c) retracting the consumable electrode rod away from the faying surface of the steel workpiece to thereby strike an arc across a gap formed between the consumable electrode rod and the faying surface of the steel workpiece, the arc initiating melting of the leading tip end of the consumable electrode rod;
(d) protracting the consumable electrode rod forward to close the gap and bring a molten reaction material droplet that has formed at the leading tip end of the electrode rod into contact with the faying surface of the steel workpiece, the contact between the molten reaction material droplet and the faying surface of the steel workpiece extinguishing the arc; and
(e) retracting the consumable electrode rod away from the faying surface of the steel workpiece to transfer the molten reaction material droplet from the leading tip end of the consumable electrode rod to the faying surface of the steel workpiece, the molten reaction material droplet transferred to the faying surface of the steel workpiece solidifying into all or part of the reaction material deposit.

11. The method set forth in claim 10, further comprising:
repeating steps (a) to (e) one or more times to transfer multiple molten reaction material droplets to the faying surface of the steel workpiece, the multiple molten reaction material droplets combining and solidifying into the reaction material deposit.

12. The method set forth in claim 10, further comprising:
increasing the electrical current applied to the consumable electrode rod when the molten reaction material droplet that has formed at the leading tip end of the electrode rod is in contact with the faying surface of the steel workpiece and the arc has been extinguished.

13. The method set forth in claim 8, wherein compressing the reaction material deposit between the aluminum workpiece and the steel workpiece comprises:
contacting a first side of the workpiece stack-up with a first electrode and contacting a second side of the workpiece stack-up with a second electrode;
converging the first and second welding electrodes to apply a clamping force against the first and second sides of the workpiece stack-up and to generate a compressive force on the reaction material deposit.

14. The method set forth in claim 13, wherein heating the reaction material deposit comprises:
passing an electrical current between the first and second welding electrodes and through the reaction material deposit.

15. The method set forth in claim 14, wherein the electrical current that is passed between the first and second welding electrodes and through the reaction material deposit is passed at a current level that ranges from 2 kA to 40 kA for a duration of 50 ms to 5000 ms.

16. The method set forth in claim 8, wherein the localized molten phase of intermixed aluminum and copper spreads laterally beyond the reaction material deposit between the aluminum and steel workpieces to provide a radially extended portion of the aluminum-copper alloy that surrounds the reaction material deposit and establishes a secondary braze joint with the steel workpiece and a secondary fusion joint with the aluminum workpiece.

17. A workpiece stack-up that includes an aluminum workpiece and a steel workpiece joined together, the workpiece stack-up comprising:
a steel workpiece;
an aluminum workpiece; and
a metallurgical joint that secures the steel workpiece and the aluminum workpiece together, the metallurgical joint comprising a copper-based reaction material that establishes a bonding interface with the steel workpiece in the form of a primary braze joint and further establishes a bonding interface with the aluminum workpiece in the form of a fusion joint through an aluminum-copper alloy.

18. The workpiece stack-up set forth in claim 18, wherein the copper-based reaction material is pure unalloyed copper or a copper alloy having a minimum copper constituent content of 50 wt %, the copper alloy being one of a copper-phosphorus alloy, a copper-silver-phosphorus alloy, a copper-tin-phosphorus alloy, a copper-zinc alloy, an aluminum-bronze alloy, or a silicon-bronze alloy.

19. The workpiece stack-up set forth in claim 18, wherein the metallurgical joint further comprises a radially extended portion of the aluminum-copper alloy that surrounds the reaction material and establishes a secondary braze joint with the steel workpiece and a secondary fusion joint with the aluminum workpiece.

20. The workpiece stack-up set forth in claim 18, wherein the workpiece stack-up includes an additional aluminum workpiece and/or an additional steel workpiece in addition to the aluminum workpiece and the steel workpiece between which the metallurgical joint is formed.
